(19) United States
(12) Patent Application Publication
(10) Pub. No.: US 2007/0237591 A1
(43) Pub. Date: Oct. 11, 2007

(54) Electrical hand-held tool with a cooling fan

(76) Inventor: Oliver Ohlendorf, Landsberg (DE)

Correspondence Address: ABELMAN, FRAYNE & SCHWAB, 666 THIRD AVENUE, 10TH FLOOR, NEW YORK, NY, 10017, US

(21) Appl. No.: 11/732,840

(22) Filed: Apr. 4, 2007

(30) Foreign Application Priority Data
Apr. 6, 2006 (DE) 10 2006 000 162.1

(51) Int. Cl. B23B 51/06; B23B 27/10

(52) U.S. Cl. 408/61; 408/58

(57) ABSTRACT

An electrical hand-held tool (1) includes a working tool-side assembly (2) located in the tool outer housing (3), a cooling fan (4) also located in the outer housing (3), at least one cooling air conduit (5) extending between a working tool-side end of the assembly (2) and the cooling fan (4), and barrier element (7) provided on a cooling fan-side of the cooling air conduit (5) in the vicinity of the cooling fan (4) and having a barrier opening (14) that opens toward the cooling fan (4).

### BACKGROUND OF THE INVENTION

1. Field of the Invention

The present invention relates to an electrical hand-held tool such as chisel hammer, combination hammer, compass saw, saber saw, etc., with a cooling fan for producing a cooling air flow for cooling the tool motor.

2. Description of the Prior Art

With the electrical hand-held tools, and with cooling high-power electric motors, if needed, the outgoing air is put to other uses. E.g., in U.S. Pat. No. 6,126,368, the outgoing air is used for blowing over a working tool or a workpiece.

According to German publication DE 19626254, a warm outgoing air flows under a slight air overpressure through a cooling channel between the percussion mechanism assembly and the outer housing up to a working tool-side striking tool holder provided on the spindle, being used there for cooling the outer surface of the guide sleeve that became very heated as a result of sliding friction resulting from an axial limited displacement therein of the striking tool.

With an abrasive working of stone by electrical hand-held tools used for this purpose, the air, which is aspirated by the cooling fan from outside, has a high concentration of dust, so that the above-mentioned use of the outgoing air for cooling the dust-sensitive constructional units is limited. In particular, such outgoing air cannot be used, without further means, for rinsing dust-sensitive units such as dies with a chamber or inner surfaces of guide sleeves, specifically, when the air is under relatively high overpressure.

European application EP 1302281 discloses a percussion electrical hand-held tool including a percussion mechanism assembly axially displeaceable, within certain limits, in an outer housing and an interior cooling fan. There is also provided a cooling air conduit that is fixedly connected with the percussion mechanism assembly and extends between air openings in the vicinity of the working tool holder and the electric motor, for cooling air entry at the electric motor. The heated outgoing air is carried away through outgoing air openings in the outer housing.

The object of the invention is to provide means for producing dust-poor outgoing air with relatively high air overpressure from an interior cooling fan of the electric motor.

### SUMMARY OF THE INVENTION

This and other objects of the present invention, which will become apparent hereinafter, are achieved by providing an electrical hand-held tool including an outer housing, a working tool-side assembly located in the outer housing, a cooling fan also located in the outer housing, at least one cooling air conduit extending between a working tool-side end of the assembly and the cooling fan, and barrier means provided on a cooling fan-side of the cooling air conduit in the vicinity of the cooling fan and having a barrier opening that opens toward the cooling fan.

The barrier means that is arranged in the vicinity of the cooling fan and has a barrier opening facing the cooling fan increases the dynamic pressure, which physically is proportional to a square of the flow velocity. As a result of the flow resistance within the cross-section of the entire flow, there is provided on the impact side of the barrier means a relatively high air ovepressure in comparison with the medium static air pressure on the pressure side of the cooling fan. Thus, a small portion of the cooling air volume with a relatively high air overpressure is taken away from the interior cooling fan of the electric motor and becomes available for further use, in particular, for delivery to a working tool-side end of the working tool-side assembly by a cooling air conduit.

Preferably, a sealing clearance which is formed between the cooling fan and the barrier opening is smaller than a smallest opening width of the barrier opening. Thereby only unsubstantial portion of the cooling air flow can escape through the sealing clearance.

Advantageously, the barrier opening is slot-shaped, and a longitudinal extension of the barrier opening is oriented transversely to a dust-tightness gradient within the flow cross-section in a flow cross-sectional region with a lower dust-tightness. As a result of this filter acton, only outgoing air with a reduced dust content reaches the cooling air conduit. Such dust-tight gradients are formed physically at each curve of the cooling air flow (cyclone effect), in particular when a suction-side cooling air flow for cooling the electric motor that flows axially with respect to the motor axis, is converted into a radial cooling air flow that flows through a centrifugal blower and is compressed at the pressure side of the blower.

Advantageously, at least one longitudinal edge of the barrier opening, which is arranged in the flow cross-section, is formed sharp-edged in a direction opposite the flow direction, whereby the longitudinal edge itself forms a minimal flow resistance to the cooling flow and, thereby, divides the flow almost ideally (in a small cooling air volume with a relatively high air overpressure and a larger remaining volume with a slightly increased static air pressure).

Advantageously, the barrier means is radially spaced from the cooling fan, which is formed as a centrifugal blower, with the barrier opening being oriented radially inward and also toward the working tool side. This ensures a space-saving arrangement of the barrier means in the outer housing of the electrical hand-held tool.

Advantageously, at least one longitudinal edge of the barrier opening which lies in a centrifugal blower plane, is formed as an arc segment.

Due to this symmetrical adaptation, a uniform radial clearance is achieved.

Advantageously, the entire cross-section of the cooling air conduit is greater than the barrier opening. As a result, the flow velocity within the cooling air conduit is smaller than in the barrier means, whereby the transmittable with the flow, dust at least partially rests on the cross-section transitional region of the cooling air conduit, and is not transported further.

While the cooling air conduit can have any arbitrary cross-section, advantageously, it has a circular tubular cross-section. Thereby, at the same cross-sectional surface, conduit length, and pressure difference, a maximal air flow rate is achieved. This is because with laminar flow, flow edges cause friction which is minimal with a circular cross-section.

Advantageously, there are provided several cooling air conduits which permits to transport the cooling air with a relatively high air overpressure to different locations technologically easy.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a longitudinal cross-sectional view of an electrical hand-held power tool;

FIG. 2 a longitudinal cross-sectional view at an increased, in comparison with FIG. 1, scale of a detail II in FIG. 1; and

FIG. 3 a perspective view of barrier means.

### DETAILED DESCRIPTION OF THE PREFERRED EMBODIMENT

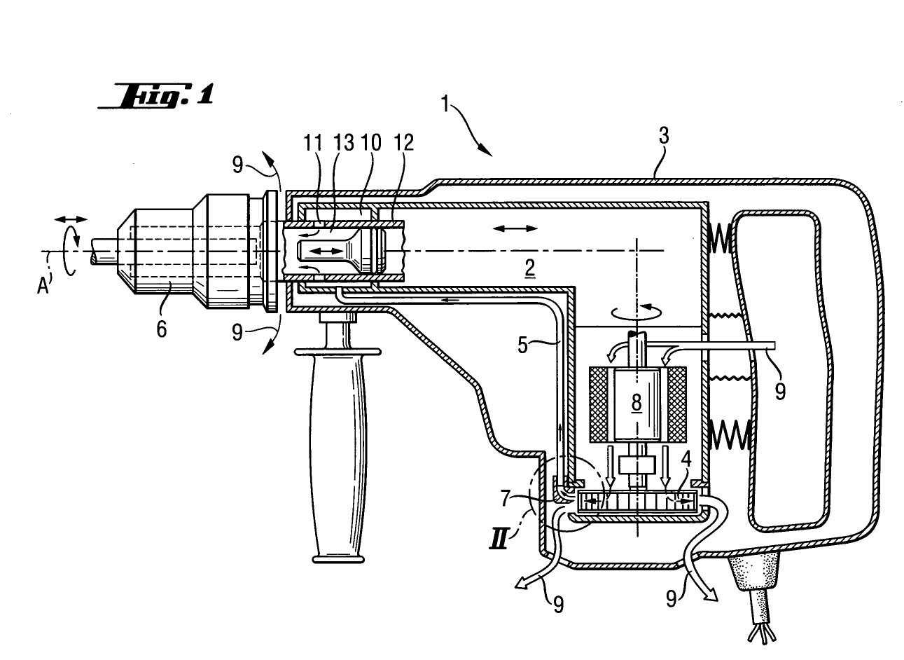

An electrical hand-held tool 1, which is shown in FIG. 1, includes an outer housing 3, a working tool-side assembly 2 in form of a percussion mechanism assembly that is supported in the outer hosing 3 for a limited axial displacement therein and that imparts blows along a rotational axis A, and an inner cooling fan 4 in form of a centrifugal blower located in a cooling air conduit. The cooling air conduit 5 extends between the working tool-side end of the working tool-side assembly 2 at which a chuck 6 is secured, and the cooling fan 4. At the fan side, the cooling air conduit 5 includes barrier means 7. A small portion of a cooling air 9 which is aspirated by the cooling fan 4 through the outer housing 3 and a substantial portion of which, after cooling an electric motor 8, is blown out, enters, through the barrier means 7, the tubular cooling air conduit 5, an air-tight annular space 10, and openings 11 of a guide tube 12 into the antechamber of a die 13 axially displaceable, within limits, in a guide tube 12 and, finally, the chuck 6 that releases this portion of the cooling air 9 again into the atmosphere.

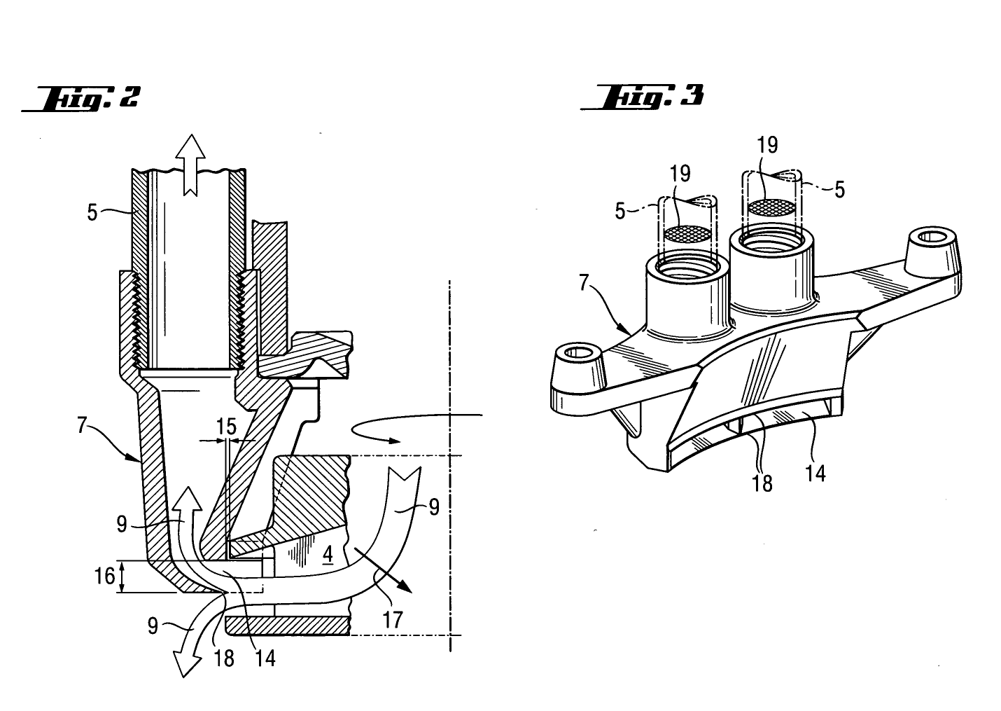

As shown in detailed view in FIG. 2, the barrier means 7, with a barrier opening 14 that opens radially inwardly toward the rotatable cooling fan 4, provides for an increase of the air flow of the cooling air 9 that flows through the cooling fan 9. To this end, the barrier means 7 is arranged adjacent to the cooling fan 7 at a radial distance therefrom which is so selected that a sealing clearance 15 between the radially outer edge of the cooling fan 4 and the barrier opening 14 is substantially smaller than the opening width of the slot-shaped barrier opening 14, i.e., smaller than the slot width 16. The longitudinal extension of the barrier opening 14 runs transverse (here perpendicular to the plane of the drawing) to a dust-tightness gradient 17 within a curved flow cross-section and is arranged within a flow cross-sectional region with a lower dust-tightness (here in the upper part of the drawing). The longitudinal edges 18 of the barrier opening 14, which are located in the flow cross-section, are formed so that they are sharp-edged in the direction opposite the flow direction.

FIG. 3 shows that with the barrier means 7 being located in the plane of a centrifugal blower, the longitudinal edges 18 of the barrier opening 14 have a shape of an arc segment. At that, the common cross-section 19 of both tubular cooling air conduits 5 is greater than the slot-shaped barrier opening 14.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An electrical hand-held tool (1), comprising an outer housing (3); a working tool-side assembly (2) located in the outer housing (3); a cooling fan (4) also located in the outer housing (3); at least one cooling air conduit (5) extending between a working tool-side end of the assembly (2) and the cooling fan (4); and barrier means (7) provided on a cooling fan-side of the cooling air conduit (5) in the vicinity of the cooling fan (4) and having a barrier opening (14) that opens toward the cooling fan (4).

2. An electrical hand-held tool according to claim 1, wherein a sealing clearance (15), which is formed between the cooling fan (4) and the barrier opening (14) is smaller than a smallest opening width of the barrier opening (14).

3. An electrical hand-held tool according to claim 1, wherein the barrier opening (14) is slot-shaped, a longitudinal extension of the barrier opening (14) is oriented transversely to a dust-tightness gradient(17) within the flow cross-section in a flow cross-sectional region with a lower dust-tightness.

4. An electrical hand-held tool according to claim 3, wherein at least one longitudinal edge (18) of the barrier opening (14), which is arranged in the flow cross-section, is formed sharp-edged in a direction opposite a flow direction.

5. An electrical hand-held tool according to claim 1, wherein the cooling fan (4) is formed as a centrifugal blower, the barrier means (7) being radially spaced from the centrifugal blower, with the barrier opening (14) being oriented radially inward.

6. An electrical hand-held tool according to claim 5, wherein at least one longitudinal edge (18) of the barrier openings (14), which lies in a centrifugal blower plane, is formed as an arc segment.

7. An electrical hand-held tool according to claim 1, wherein the cooling air conduit (5) has a cross-section (19) that is greater than the barrier opening (14).

8. An electrical hand-held tool according to claim 1, wherein the cooling air conduit (5) is formed as a circular tubular conduit.

9. An electrical hand-held tool according to claim 1, comprising several cooling air conduits (5).
